(19) United States
(12) Patent Application Publication
(10) Pub. No.: US 2016/0379522 A1
(43) Pub. Date: Dec. 29, 2016

(54) DAILY FLUID INTAKE REGULATING APPARATUS AND METHOD OF REGULATING FLUID INTAKE

(71) Applicant: Karen S. Bush, Melvin, MI (US)

(72) Inventor: Karen S. Bush, Melvin, MI (US)

(21) Appl. No.: 15/191,173

(22) Filed: Jun. 23, 2016

Related U.S. Application Data
(60) Provisional application No. 62/183,840, filed on Jun. 24, 2015.

(51) Int. Cl. G09B 19/00

(52) U.S. Cl. CPC G09B 19/0092

(57) ABSTRACT

A daily fluid volume intake regulating apparatus and method of regulating daily volume intake of fluid are provided. The apparatus includes a plurality of members strung together along a cord. Each of the plurality of members represents a portion of a total daily volume of fluid to be ingested within the course of a day, wherein the totality of members represent the total daily volume of fluid to be ingested within the course of a single day. The plurality of members are selectively moveable separately from one another along the cord from a non-ingested first position, representing fluid remaining to be ingested within the course of the day, to an ingested second position, representing fluid already ingested within the course of the day.

### CROSS-REFERENCE TO RELATED APPLICATION

This application claims the benefit of U.S. Provisional Application Ser. No. 62/183,840, filed Jun. 24, 2015, which is incorporated herein by reference in its entirety.

### BACKGROUND OF THE INVENTION

1. Technical Field

This invention relates generally to apparatus and methods for regulating human intake of fluid, and more particularly to apparatus and methods for regulating human daily volume fluid intake.

2. Related Art

It is known that water is the human body's principal chemical component. Water makes up about 60 percent of the body's weight, and virtually every system in the body depends on water. Some of the important roles water plays are as follow: water flushes toxins out of vital organs, carries nutrients to cells, and provides a moist environment for ear, nose and throat tissues. Lack of water can lead to dehydration, a condition that occurs when the body does not have enough water to carry out normal functions. Even mild dehydration can drain the energy of a body and thus, result in fatigue, among other things. This said, it is generally known that the human body needs to have a proper daily intake of fluid to maintain optimal function and health.

The amount of fluid intake that is optimal for a human body generally varies from one person to another, depending on the make-up or physical attributes of the individual's body. Regardless, it is important that each person take in the optimal amount of fluid over the course of a day to ensure their body is receiving the fluid it needs to function properly. In addition to taking in enough fluid, it is equally important to avoid over-hydrating the body, as this can result in negative consequences to the body, such as overworking the kidneys and impacting their ability to regulate optimal water content within the blood stream. This is particularly important in the presence of some specific disease states where excess fluid or insufficient fluid can have detrimental effects. Accordingly, a delicate balance of daily fluid intake needs to be maintained to provide the body with an optimized ability to remain healthy.

### SUMMARY OF THE INVENTION

A daily fluid volume intake regulating apparatus is provided in accordance with one aspect of the invention. The apparatus includes a plurality of members strung together along a cord. Each of the plurality of members represents a portion of a total daily volume of fluid to be ingested within the course of a day, wherein the plurality of members combined represent the total daily volume of fluid to be ingested within the course of a single day. The plurality of members are selectively moveable separately from one another along the cord from a non-ingested first position, representing fluid remaining to be ingested within the course of the day, to an ingested second position, representing fluid already ingested within the course of the day.

In accordance with another aspect of the invention, the plurality of members can be provided to consist of eight members, with each of the members representing eight fluid ounces.

In accordance with another aspect of the invention, a last member in the string of the plurality of members can be provided having a different appearance from the other members to provide enhanced recognition to the user that only one portion of the fluid to be ingested within the course of the day remains.

In accordance with another aspect of the invention, the plurality of members can be arranged in three distinctive groups, with each of the groups having a different appearance from one another, wherein the last member solely represents one of said groups.

In accordance with another aspect of the invention, the members in a first of the three distinctive groups can be provided as green to represent an all clear “go state” to indicate to the person they are free to consume fluid; the members in a second of the three distinctive groups can be provided as yellow to represent a “caution state” to indicate to the person they are nearing an end of the fluid to be consumed within the course of the day, and the last member can be provided as red to represent a “stop state” when moved to the ingested position to indicate to the person that they have consumed their daily allowance of fluid.

In accordance with another aspect of the invention, the last member can be provided having a different shape from the other members to provide a tactile indicator to the person in case the person is visually impaired for any reason, including being in a dark environment.

In accordance with another aspect of the invention, the plurality of members can be arranged in three distinctive groups, with each of the groups having a different shape from one another, with the last member solely representing one of the three distinctive groups.

In accordance with a further aspect of the invention, a method of regulating a daily fluid volume intake by a person over the course of a day is provided. The method includes providing a plurality of members strung together along a cord to represent the total daily volume of fluid to be ingested over the course of the day. The method further includes designating each of the plurality of members to represent a portion of the total daily volume of fluid to be ingested. The method further yet includes allowing each of the plurality of members to be moved along the cord from a non-ingested first position to an ingested second position, upon ingesting the designated volume of fluid represented by the member being moved, to indicate when to stop ingesting fluid for the remainder of the current day upon a last of the members being moved to the ingested second position.

In accordance with another aspect of the invention, the method can further include providing the plurality of members as eight members with each of the eight members representing ⅛ of the total daily fluid volume intake.

In accordance with another aspect of the invention, the method can further include providing the last member having a different appearance from the remaining plurality of members.

In accordance with another aspect of the invention, the method can further include arranging the plurality of members in three distinctive groups; providing each of the groups having a different appearance from one another, and representing one of the groups solely by the last member.

In accordance with another aspect of the invention, the method can further include providing the members in a first of the three distinctive groups as being green, providing the members in a second of the three distinctive groups as being yellow, and providing the last member as being red.

In accordance with another aspect of the invention, the method can further include providing the last member having a different shape from the other members, thereby enhancing the ability of a visually impaired user to recognize when the total daily fluid allowance for the day is near or has been reached, depending on the relative position of the last member.

In accordance with another aspect of the invention, the method can further include arranging the plurality of members in three distinctive groups and providing each of the members within the same group having the same shape as one another and providing the members within different groups having a different shape from one another, thereby enhancing the ability of a visually impaired user to recognize where they stand with regard to the remaining amount of fluid to be consumed with the current day.

### BRIEF DESCRIPTION OF THE DRAWINGS

These and other features and advantages will become readily apparent to those skilled in the art in view of the following detailed description of the presently preferred embodiments and best mode, appended claims, and accompanying drawings, in which:

FIGS. 1-4 are schematic elevation views of a daily volume fluid intake apparatus constructed in accordance with one presently preferred embodiment of the invention shown in various states of use.

### DETAILED DESCRIPTION OF PREFERRED EMBODIMENTS

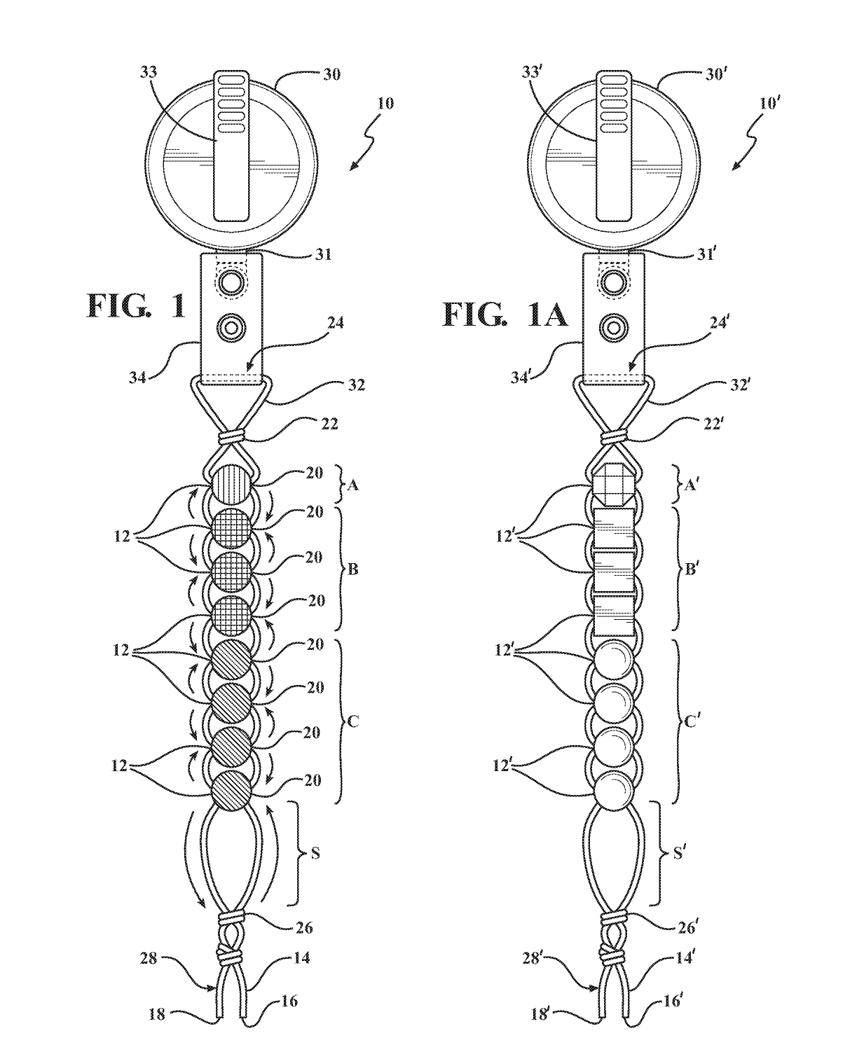

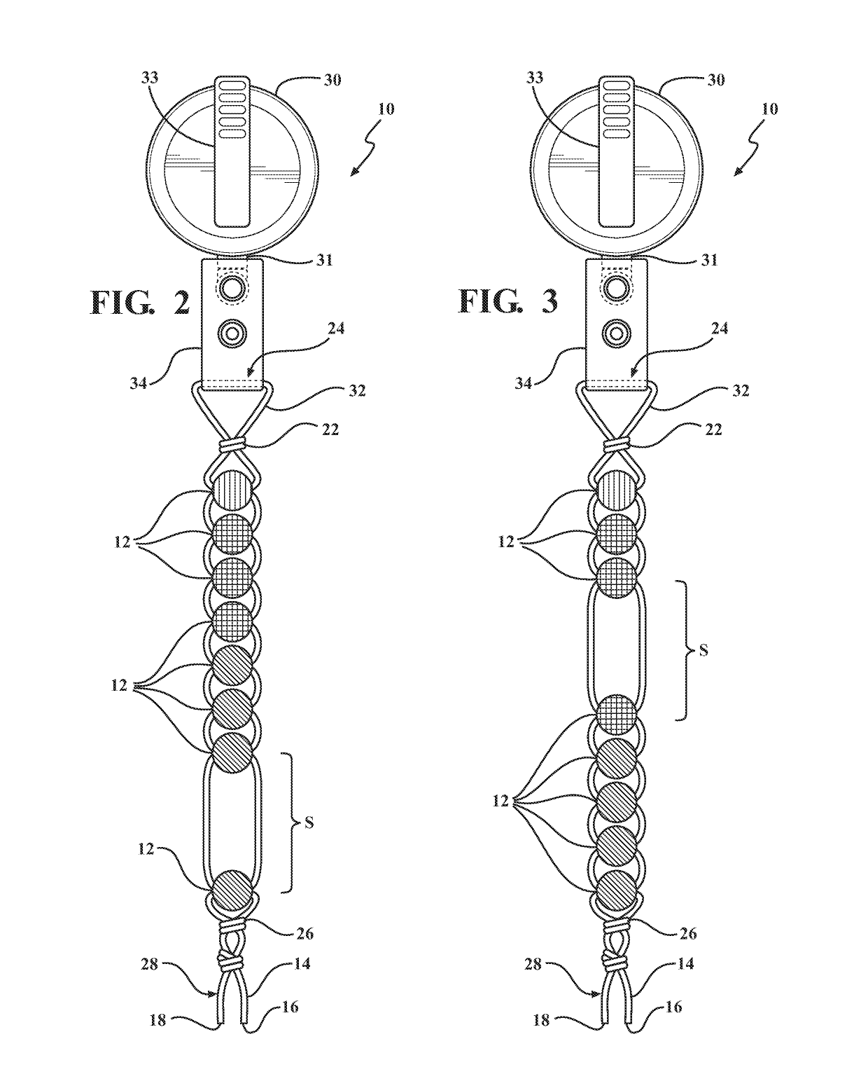

Referring in more detail to the drawings, FIGS. 1-4 show a daily fluid volume intake regulating apparatus, referred to hereafter as apparatus 10, in accordance with one aspect of the invention. The apparatus 10 includes a plurality of members 12 strung together along a cord 14, such as one or more filaments of yarn, string, wire, or the like. Each of the plurality of members 12 represent a portion (fractional amount) of a total daily volume (V) of fluid to be ingested over the course of a single day (24 hour period), with the plurality of members 12 combined representing the total daily volume V of fluid to be ingested over the course of the day. Each of the plurality of members 12 are selectively moveable separately from one another along the cord 14 from a non-ingested first position (FIG. 1 shows all members 12 in the non-ingested first position), representing the amount of fluid remaining to be ingested over the course of the day, to an ingested second position (FIGS. 2-4 show different numbers of the members 12 moved from the first position to the second position), representing the amount of fluid already ingested within the course of the day. As such, the members 12 provide a direct visual and/or tactile indication to the person how much fluid remains to be ingested within the course of the day via the members remaining in the non-ingested first position and how much fluid has already been ingested within the course of the day via the members moved to the ingested second position. Accordingly, the person does not need to remember from one moment to the next how much fluid has already been ingested, as the apparatus 10, if properly used, indicates the volume of fluid already ingested versus the volume of fluid remaining to be ingested.

The cord 14 is shown as being a continuous length of string extending from one free end 16 to an opposite free end 18. The members 12 can be provided as beads of any type of material, and are shown as having through openings 20 through which the cord 14 extends. The cord 14 is shown as having two segments extending through each through opening 20, with the cord 14 meandering upwardly in serpentine type fashion between adjacent members 12 and then meandering downwardly in opposite serpentine type fashion between adjacent members 12, as indicated by upwardly and downwardly directed arrows in FIG. 1. The cord 14 is shown as having a knot 22 formed adjacent an upper or first end 24 of the apparatus 10 and a knot 26 formed at a lower or second end 28 of the apparatus, thereby containing the members 12 on the cord 14. The cord 14 extends through the through openings 20 and about a portion of an outer periphery of the members 12 in such a fashion as to impart friction against the members 12 within the through openings 20 and against the outer periphery, thereby acting to prevent or inhibit free sliding movement of the members 12 along the cord 14 absent some suitable externally applied pulling or pushing force. Accordingly, the members 12 remain in their intended position until selectively acted on by a suitable pulling or pushing force. It should be recognized that a certain amount of space or slack S is intentionally left in the cord 14 between the opposite knots 22, 26 to allow the members 12 to be slid along the cord 14 toward and away from one another, as desired, during use.

The apparatus 10 can have a feature 30, which in turn can include a handle, badge, extendable member 31, and/or clip 33 otherwise affixed to the upper end 24, shown as being fixed to a loop 32 of the cord 14 above the upper knot 22 via a fastener 34, by way of example and without limitation. The feature 30 can be used to facilitate carrying and/or for identification purposes, as desired. The extendable member 31 is provided including a spring biases member with a cord operably fixed thereto, thereby allowing the user to pull the members 12 and cord 14 outwardly and away from the feature 30, which can remain fixed to a garment worn by the user. As such, ready access is made available to the bead members 12 when desired to move or observe their relative positions as a reminder of how much fluid has been consumed.

As shown in FIGS. 1-4, the apparatus, in accordance with one embodiment of the invention, has eight (8) members 12 slidably coupled on the cord. It should be recognized that more or fewer members 12 could be used; however, it is generally accepted that about eight, 8 fl-oz (fluid-ounce) servings of fluid, totaling 64 fl-oz, make up a typical person's daily requirement of fluid. The fluid is preferably water, though other fluids, such as coffee, juice, milk, or otherwise, are to be included in the daily total volume V of fluid intake, including substantially anything that is fluid at room temperature, including jello, ice-cream, soup broth, and the like. Those skilled in nutrition and the medical sciences will recognize that different people have different optimal daily volumes of fluid intake, and thus, each member 12 can be readily assigned any volume of fluid, other than 8 fl-oz, as necessary, such that the number of members 12 multiplied by their assigned fluid volume value total the optimal total daily volume V of fluid intake for the user.

In FIG. 1, the apparatus 10 is shown in a pre-use, pre-fluid consumption state for the day, wherein all the members 12 are located in an initial use state. In the initial use state, all the members 12 are pushed together toward one end of the apparatus 10, shown as the upper end 24, by way of example. In this state, the members 12 indicate that the user has yet to ingest any fluid, and thus, still should ingest a full daily allowance of fluid.

In FIG. 2, the apparatus 10 has been used at some point within the course of a day by a user and indicates that the user has ingested one (1) member's value of liquid, such as 8 fl-oz, by way of example and without limitation. The user simply applied a suitable force to cause the member 12 to slide along the cord 14 away from the remaining members 12. As such, hereafter, the user can simply refer to the apparatus 10 to see or otherwise discern that the volume of fluid represented by the 7 remaining members remains to be ingested over the remainder of the day.

In FIG. 3, the apparatus 10, at some latter point in the day relative to FIGS. 1 and 2, indicates that the user has consumed a total of five (5) member's value of liquid, such as a total of 40 fl-oz over the course of the day thus far, by way of example and without limitation. As such, by referring to the apparatus 10, the user can discern that the volume of fluid represented by the 3 remaining members 12 yet to be moved, such as a total of 24 fl-oz, remains to be consumed over the remainder of the day.

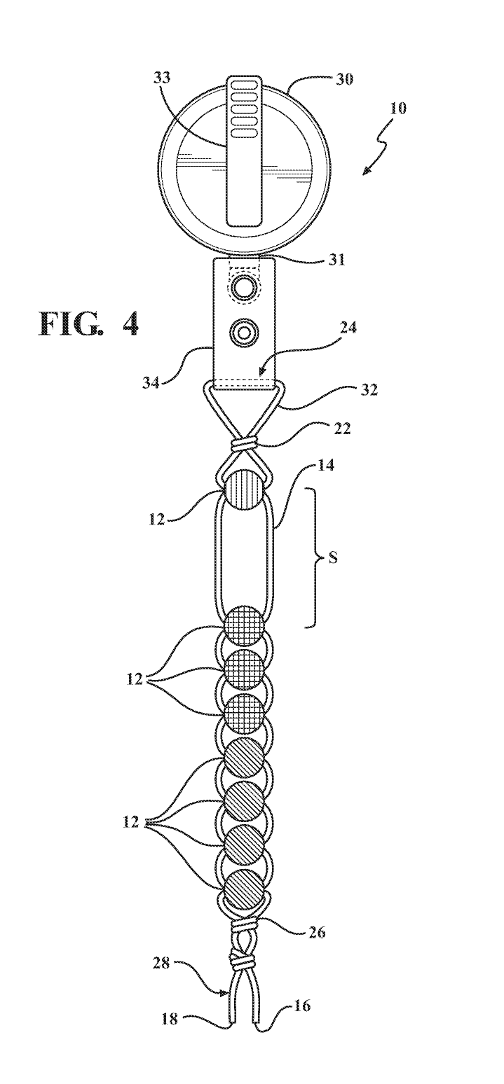

In FIG. 4, the apparatus 10 indicates that the user has ingested seven (7) member's value of liquid, such as 56 fl-oz, over the course of the day thus far, by way of example and without limitation. As such, by referring to the apparatus 10, the user can discern that the volume of fluid represented by the 1 remaining member 12, such as 8 fl-oz, remains to be consumed over the remainder of the day.

To further act as an indicator of the amount of fluid ingested and of the amount of fluid remaining to be ingested, at least some of the plurality of members 12 can be different in appearance from others of the plurality of members 12, thereby indicating to the person a particular condition at any given moment, such as an “all clear” or “cautionary” indicator to alert the person to how much fluid has been or remains to be ingested. For example, in FIGS. 1-4 it is shown that the first four members 12 are provided in one group C having one appearance; the next three members 12 are provided in another group B having a different appearance, and the last member 12 for by itself a last group A having yet a different appearance. By differing the appearance of these members 12 within the different groups A, B, C, the user, aside from counting the number of members 12, has a direct visual and/or tactile (FIG. 1A) reminder of the amount of fluid consumed versus how much fluid remains to be consumed over the course of the day. The distinguishing features of the members 12 can be in the form of color, size, shape, texture, or otherwise. As shown in FIG. 1, when the user has yet to drink any fluid, the first few members 12, shown as four in group C, by way of example, can have an “all clear to drink fluid” or “go” appearance, such as by the members 12 having a green appearance, if color is used as the distinguishing feature. Then, when the user reaches the state in FIG. 3, a cautionary appearance can be indicated by the next few members 12 of group B, shown as three, such as by the members 12 having a yellow appearance. Further yet, as shown in FIG. 4, the last member 12 of group A can have an “alerting”, warning appearance, such as by having a red appearance, indicating that the person can only consume one more of the member's value in volume of fluid, such as 8 fl-oz, by way of example and without limitation.

In addition to color, to provide an ability to discern the consumed/unconsumed volumes of fluid, the members 12 can have different shapes, textures or the like, thereby allowing the user to readily feel and distinguish the members 14 from one another. As an example, FIG. 1A shows an apparatus 10′ in accordance with another aspect of the invention, wherein the same reference numerals as used above, with a prime symbol, are used to identify like features as described above. In the embodiment illustrated, the last member 12′, nearest the feature 30′, has a different shape from the other members 12′, and is shown as being a spherical polygon, by way of example and without limitation. In addition to the last member 12′, the remaining members 12′ can also have varying shapes for ready identification. For example, the members 12′, as with the colored embodiment shown in FIG. 1, can be arranged in three distinctive groups A′, B′, C′, with each of the groups A′, B′, C′ having a different shape from one another, wherein the last member 12′ solely forms one of the groups A′, with the remaining members 12′ forming the other two groups B′, C′. The members 12′ of Group B′ are shown as being generally cylindrical, while the members 12′ of group C′ are shown as being generally spherical, by way of example and without limitation.

In accordance with a further aspect of the invention, a method of regulating a daily fluid volume intake by a person over the course of a day is provided. The method includes providing an apparatus 10′ having a plurality of members 12, 12′ strung together along a cord 14, 14′; designating said plurality of members 12, 12′ to represent the total daily volume V of fluid to be ingested; designating each of the plurality of members 12, 12′ to represent a portion of the total daily volume V of fluid to be ingested; and allowing each of the plurality of members 12 to be moved along the cord 14, 14′ from a non-ingested first position to an ingested second position upon ingesting the designated volume of fluid represented by the member 12, 12′ being moved; and indicating to the person to stop ingesting fluid for the remainder of the current day via moving the last member 12, 12′ remaining in the non-ingested first position to the ingested second position.

The method can further include providing at least some of the plurality of members 12, 12′ having a different appearance from others of the plurality of members 12, 12′ thereby alerting the user to a particular condition. Further yet, the method can include providing the different appearance via at least one of a visual indicator, such as color, for example, and/or an appearance and tactile indicator, such as size, shape, or texture, for example. Further yet, the method can include providing the last member 12, 12′ along the cord 14, 14′ having a different appearance from the remaining plurality of members 12, 12′, thereby alerting the user that only one allotted portion of fluid remains to be consumed before reaching the total daily volume intake of fluid V.

It should be recognized that the apparatus 10, 10′ serves to regulate the daily intake of fluid, and that the apparatus is reusable by resetting the members 12, 12′ to the start position at the beginning of a new day.

Obviously, many modifications and variations of the present invention are possible in light of the above teachings. It is, therefore, to be understood that within the scope of the appended claims, the invention may be practiced otherwise than as specifically described.

What is claimed is:

1. A daily fluid volume intake regulating apparatus, comprising:
a plurality of members strung together along a cord, each of said plurality of members representing a portion of a total daily volume of fluid to be ingested within the course of a day, with said plurality of members combined representing said total daily volume of fluid to be ingested within the course of the day, each of said plurality of members being selectively moveable separately from one another along said cord from a non-ingested first position, representing fluid remaining to be ingested within the course of the day, to an ingested second position, representing fluid already ingested within the course of the day.

2. The daily fluid intake regulating apparatus of claim 1 wherein said plurality of members consists of eight members, with each of said members representing eight fluid ounces.

3. The daily fluid intake regulating apparatus of claim 1 wherein a last member in the string of said plurality of members has a different appearance from the other members.

4. The daily fluid intake regulating apparatus of claim 3 wherein said plurality of members are arranged in three distinctive groups, with each of said groups having a different appearance from one another, said last member consisting of one of said groups.

5. The daily fluid intake regulating apparatus of claim 4 wherein said members in a first of said three distinctive groups are green, said members in a second of said three distinctive groups are yellow, and said last member is red.

6. The daily fluid intake regulating apparatus of claim 3 wherein said last member has a different shape from said other members.

7. The daily fluid intake regulating apparatus of claim 6 wherein said plurality of members are arranged in three distinctive groups, with each of said groups having a different shape from one another, with said last member consisting of one of said three distinctive groups.

8. A method of regulating a daily fluid volume intake by a person over the course of a day, comprising:
providing a plurality of members strung together along a cord to represent the total daily volume of fluid to be ingested over the course of the day;
designating each of said plurality of members to represent a portion of the total daily volume of fluid to be ingested; and
allowing each of said plurality of members to be moved along said cord from a non-ingested first position to an ingested second position, upon ingesting the designated volume of fluid represented by the member being moved, to indicate when to stop ingesting fluid for the remainder of the current day upon a last of the members being moved to the ingested second position.

9. The method of claim 8 further including providing the plurality of members as eight members with each of said eight members representing ⅛ of the total daily fluid volume intake.

10. The method of claim 8 further providing the last member having a different appearance from the remaining plurality of members.

11. The method of claim 10 further including arranging the plurality of members in three distinctive groups, providing each of the groups having a different appearance from one another, and representing one of the groups solely by the last member.

12. The method of claim 11 further including providing the members in a first of said three distinctive groups as being green, providing the members in a second of said three distinctive groups as being yellow, and providing said last member as being red.

13. The method of claim 10 further including providing the last member having a different shape from the other members.

14. The method of claim 13 further including arranging the plurality of members in three distinctive groups and providing each of the members within the same group having the same shape as one another and providing the members within different groups having a different shape from one another.
